(19) United States
(12) Patent Application Publication
(10) Pub. No.: US 2005/0220663 A1
(43) Pub. Date: Oct. 6, 2005

(54) Method of reducing toilet odor

(75) Inventors: David Weck, Miami, FL (US); Erwin Frey, Ft. Lauderdale, FL (US); Edson A. Mejia, Miami, FL (US); Steven C. Berenson, Miami Beach, FL (US)

Correspondence Address: LOWE HAUPTMAN GILMAN AND BERNER, LLP, 1700 DIAGONAL ROAD, SUITE 300 /310, ALEXANDRIA, VA, 22314, US

(73) Assignee: MICASA TRADING CORPORATION

(21) Appl. No.: 10/815,692

(22) Filed: Apr. 2, 2004

(51) Int. Cl. A01N 1/00; C23F 11/00

(52) U.S. Cl. 422/5; 422/1; 422/6; 424/76.1; 424/76.5; 424/76.6; 424/76.7

(57) ABSTRACT

Odor emanating from feces deposited by a human making a bowel movement in a toilet is reduced or eliminated by applying a liquid deodorizer to the bowl of the toilet immediately prior to making the bowel movement. The liquid deodorizer is applied as a spherical droplet spray including one or more enzymes.

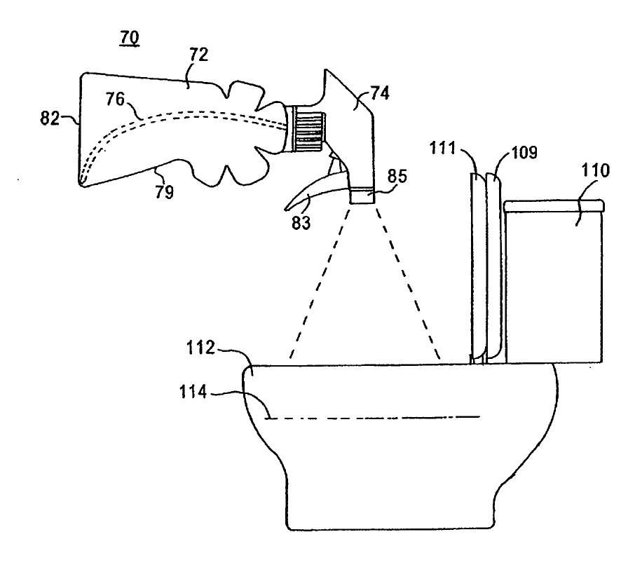

### FIELD OF THE INVENTION

The present invention relates in general to a method of reducing toilet odor and, more particularly, to a method of reducing odor emanating from feces deposited by a human making a bowel movement in a toilet, wherein a liquid deodorizer is applied to the toilet immediately prior to making the bowel movement.

### BACKGROUND ART

Many approaches have been devised for reducing and attempting to eliminate unpleasant odors emanating from feces deposited by a human making a bowel movement in a toilet. One of the methods involves using an exhaust fan to suck air from the area where the toilet is located. This method is usually ineffective, noisy, and relatively expensive with respect to fan installation. Other methods involve the use of agents that attempt to mask the odor. Usually, such agents are applied in the vicinity of the toilet after making a bowel movement. In this method, one repugnant odor is frequently replaced by another. As a result, there is a considerable amount to be desired in using the prior art techniques for reducing or attempting to remove the odor emanating from feces deposited by a human making a bowel movement in a toilet.

### SUMMARY OF THE INVENTION

The present invention relates to a method of reducing the odor emanating from feces deposited by a human making a bowel movement in a toilet by applying a liquid deodorizer to the toilet immediately prior to making the bowel movement.

The liquid is preferably applied as a spray, preferably having spherical droplets, preferably having a maximum surface area of about 78×10⁻¹² m², i.e., a diameter of about 0.0025 mm. It has been found experimentally that droplets having a surface area greater than about 78×10⁻¹² m² are not as effective as droplets having a surface area less than about 78×10⁻¹² m².

Preferably, the liquid is sequentially applied three times, once toward the center of the toilet bowl where the water pond is and then to either side of the water pond to ensure that the deodorizing liquid is incident on the water pond and solid surfaces of the bowl.

The spray is preferably sprayed from a nozzle such that the spray has a conical pattern with an apex having a solid angle of about 40° at a spray originating region.

The liquid preferably includes an enzyme, particularly the enzymes amylase, protease, and lipase. The liquid also preferably includes emulsifiers, specifically nonylphenl and propylene glycol, as well as about 90 percent water, by volume.

The above and still further objects, features, and advantages of the present invention will become apparent upon consideration of the following detailed description of a specific embodiment thereof, especially when taken in conjunction with the accompanying drawing.

### BRIEF DESCRIPTION OF THE DRAWING

The sole figure of the drawing is an illustration of a preferred method of practicing the present invention.

### DETAILED DESCRIPTION OF THE DRAWING

The figure is a diagram indicating how a liquid spray dispenser is employed for reducing and virtually eliminating odors emanating from human feces deposited in a toilet bowl as a result of a bowel movement.

To substantially reduce or eliminate the odor emanating from toilets as a result of human feces from a bowel movement being deposited therein, liquid in bottle 72 of liquid dispenser 70 of the figure is sprayed as spherical droplets from an outlet of liquid spray nozzle 74 in response to trigger 26 of the spray nozzle being squeezed, immediately before a person sits on toilet 110 to make a bowel movement.

As illustrated in the figure, liquid spray dispenser 70 is positioned so that the longitudinal axis of bottle 72 is generally horizontally disposed, and spray nozzle head 34 of spray nozzle 74 points downwardly toward bowl 112 of toilet 110. Toilet bowl cover 109 and toilet seat 111 are pivoted so that toilet bowl 112 and water pond 114 are exposed. A user then squeezes trigger 26 of nozzle 74 so that spherical liquid deodorizing droplets from bottle 72 are deposited on the walls of toilet bowl 112 and the surface of water pond 114 in toilet 110.

Preferably, trigger 26 is squeezed three or more times immediately before the user turns toilet seat 111 onto toilet bowl 112. The first spray is typically on the center of water pond 114, and the two subsequent sprays are to opposite sides of water pond 114 onto the opposite sides of toilet bowl 112. Then the user turns down toilet seat 111, sits on the seat, and makes a bowel movement immediately after spraying the liquid into bowl 112. The terms “immediately before” and “immediately after” mean the time required for the user to turn toilet seat 111 onto toilet bowl 112 and then to sit on toilet seat 111 and make a bowel movement.

The droplets in the spray preferably have a surface area no greater than about 78×10⁻¹² m², a result achieved by causing spherical droplets having a maximum diameter of about 0.0025 mm to flow from nozzle head 34. The spray emanating from nozzle head 34 has a conical pattern, with the apex of the cone flowing from nozzle head 34 having a solid angle of about 40°.

The liquid in bottle 72 for reducing or eliminating odor from feces in toilet 110 is preferably a mixture of enzymes, emulsifiers, and water. Suitable enzymes include amylase, protease, and lipase. Suitable emulsifiers include nonylphenol and propylene glycol. The water content is about 90 percent by volume.

We believe the foregoing mixture reduces or eliminates odor from excrement in toilet 110 because the mixture penetrates and breaks down the odor-generating skatol and indol molecules in human feces, as well as proteins in human feces which are known to produce offensive odors. Proteases break down protein to its component amino acids. Amylases produce simple sugars from carbohydrates. Lipases break down triglycerides to release fatty acids.

It has been found through actual experimentation that spraying the liquid having the stated composition and physical properties immediately before making a bowel movement into a toilet bowl results in very substantial, and in many cases complete, elimination of odors emanating from the toilet as a result of the bowel movement being made. The experiments indicate that spraying before making the bowel movement produces a far superior result to spraying after the bowel movement has been deposited in the toilet.

By applying the mixture as a spray before the bowel movement is made, the breakdowns would appear to occur on the surfaces where the feces are deposited before the odor-generating molecules become active.

It is believed that the enzymes interact with molecules from the gas in the feces to capture these molecules before they have an opportunity to escape from toilet bowl 112 and water pond 114.

While there has been described and illustrated a specific embodiment of the invention, it will be clear that variations in the details of the embodiment specifically illustrated and described may be made without departing from the true spirit and scope of the invention as defined in the appended claims.

1. A method of reducing the odor emanating from feces deposited by a human making a bowel movement in a toilet, comprising the step of applying a liquid deodorizer to the toilet immediately prior to making the bowel movement.

2. The method of claim 1, wherein the liquid is applied as a spray.

3. The method of claim 1, wherein the liquid is sequentially applied three or more times as a spray.

4. The method of claim 2, wherein the liquid includes an enzyme.

5. The method of claim 2, wherein the liquid includes the enzymes amylase, protease, and lipase.

6. The method of claim 1, wherein the spray consists of droplets having a maximum surface area of about 78×10⁻¹² m².

7. The method of claim 6, wherein the droplets are spherical.

8. The method of claim 7, wherein the spray is sprayed from a nozzle such that the spray has a conical pattern with an apex having a solid angle of about 40° at a spray originating region.

9. The method of claim 2, wherein the spray includes spherical droplets having a maximum diameter of about 0.0025 mm.

10. The method of claim 2, wherein the spray consists primarily of spherical droplets having a maximum diameter of about 0.0025 mm.

11. The method of claim 10, wherein the liquid includes an enzyme.

12. The method of claim 10, wherein the liquid includes the enzymes amylase, protease, and lipase.

13. The method of claim 1, wherein the liquid includes an enzyme.

14. The method of claim 1, wherein the liquid includes the enzymes amylase, protease, and lipase.

15. The method of claim 14, wherein the liquid includes emulsifiers.

16. The method of claim 14, wherein the liquid includes nonylphenol, propylene glycol, and water.

17. The method of claim 13, wherein the spray consists of droplets having a maximum surface area of about 78×10⁻¹² m².

18. The method of claim 17, wherein the liquid is applied as a spray.

19. The method of claim 18, wherein the droplets are spherical.

20. The method of claim 18, wherein the spray is sprayed from a nozzle such that the spray has a conical pattern with an apex having a solid angle of about 40° at a spray-originating region.

21. The method of claim 17, wherein the spray includes spherical droplets having a maximum diameter of about 0.0025 mm.

22. The method of claim 21, wherein the spray consists primarily of spherical droplets having a maximum diameter of about 0.0025 mm.

23. The method of claim 10, wherein the liquid is applied as a spray.

24. The method of claim 23, wherein the spray consists of droplets having a maximum surface area of about 78×10⁻¹² m².

25. The method of claim 24, wherein the droplets are spherical.

26. The method of claim 24, wherein the spray is sprayed from a nozzle such that the spray has a conical pattern with an apex having a solid angle of about 40° at a spray-originating region.

27. The method of claim 17, wherein the spray includes spherical droplets having a maximum diameter of about 0.0025 mm.

28. The method of claim 27, wherein the spray consists primarily of spherical droplets having a maximum diameter of about 0.0025 mm.
